(19) United States
(12) Patent Application Publication
(10) Pub. No.: US 2006/0076738 A1
(43) Pub. Date: Apr. 13, 2006

(54) Quick change coupler

(76) Inventor: Wende Zhou, Taizhou (CN)

Correspondence Address: JACOBSON HOLMAN PLLC, 400 SEVENTH STREET N.W., SUITE 600, WASHINGTON, DC, 20004, US

(21) Appl. No.: 11/234,226

(22) Filed: Sep. 26, 2005

(30) Foreign Application Priority Data
Oct. 8, 2004 (CN) 200420014121.3

(51) Int. Cl. B23B 31/12

(52) U.S. Cl. 279/45

(57) ABSTRACT

The present invention provides a quick change coupler. It comprises a mainbody, a rear end of the mainbody being equipped with a coupling arrangement cooperating with a driving mechanism, a front end of the mainbody being equipped with a tool coupling shaft cavity, and it is also equipped with a tool locking mechanism. The coupling arrangement can be a coupling shaft integrated with or threaded to joint the mainbody, and the front end of the mainbody is equipped with protruding keys or a groove. The coupler is capable of coupling with drill chucks or tools of different types, and has the advantages of convenient mounting and dismounting, simple and reasonable structure, easy manufacturing, and low cost.

### FIELD OF THE INVENTION

The present invention relates to a coupler powered by driving mechanisms such as a machine tool or an electric drill, which is capable of coupling with drill chucks of different types as tools for various purposes.

### DESCRIPTION OF THE RELATED ART

In the prior art, drill chucks are coupled with machine tools or air-operated or electric drills via screw holes in the drill bodies. The drawback of this coupling method is that it is inconvenient to mount and dismount the drill chucks, particularly when different types of drill chucks are required. Additionally, if automatic mounting by this method is used on machine tools, it requires not only a long time but also high technical skill for mounting the drill chucks.

### SUMMARY OF THE INVENTION

An object of the present invention is to overcome the shortcomings of prior art, and provide a multi-purpose quick change coupler that is convenient for drill chuck mounting and dismounting, and capable of direct connection to a driving mechanism. According to the present invention, the quick change coupler comprises a mainbody, a rear end of the mainbody being equipped with a coupling arrangement for cooperating with a driving mechanism, a front end of the mainbody being equipped with a tool coupling shaft cavity. Additionally, the coupler is also equipped with a tool locking mechanism, and a torque transfer mechanism for cooperating with the tool.

The coupling arrangement can be a coupling shaft integrated with the mainbody. The coupling shaft may replace or directly use a coupling shaft of the driving mechanism. Thus, the accumulated error resulting from the coupling of the main shaft of a driving mechanism with the screw threads of the coupler can be reduced, and perforating precision can be improved. The coupling arrangement can also be a coupling shaft in threaded engagement with the mainbody. Similarly, the coupling shaft is capable of replacing the coupling shaft of the driving mechanism or directly using the shaft of the driving mechanism. The coupling arrangement can also be a shaft cavity.

The locking mechanism may comprise at least one short-cone shaped non-through hole positioned at the tail end of the coupling shaft cavity wall with steel balls located therein. An operating sheath includes a raised platform and a ring groove shaped for cooperating with each of the steel balls. A spring is located between the operating sheath and the mainbody. The locking mechanism also includes a limiting clamp spring for retaining the operating sheath. The locking mechanism may also comprises an oblique slot positioned on the coupling shaft cavity wall with locking rings equipped therein, an operating sheath, springs equipped between the operating sheath and the mainbody, and a limiting clamp spring for the operating sheath.

The present invention is capable of coupling with drill chucks and tools of different types, and has the advantages of convenient mounting and dismounting, simple and reasonable structure, easy part manufacturing. Standard parts such as springs and steel balls can be manufactured at low costs.

The front end of the mainbody can be equipped with protruding keys or a groove. In this way, the torque transfer becomes more reliable. This structure is also more favorable for improving accuracy and precision.

### BRIEF DESCRIPTION OF THE DRAWINGS

FIG. 1 is a side elevational view of an embodiment of the quick change coupler according to the present invention after being assembled with an air-operated or electric power-driven drill;

FIG. 2 is a half sectional view of an embodiment of the quick change coupler of the present invention, showing the interior structure and the exterior shape of the coupler;

FIG. 3 is an enlarged view of section B in FIG. 2, showing the structure of the coupler in that section;

FIG. 4 is a right side view of FIG. 2, showing the exterior profile and the front end surface shape of the coupler;

FIG. 5 is a sectional view of FIG. 2 along C-C, showing the positions of the steel balls;

FIG. 6 is an exploded view of the embodiment, showing the exterior shape and assembling position and assembling order of each part of the coupler;

FIG. 7 is a side elevational view of a second embodiment of the quick change coupler, showing the exterior shape and the front end shape of the coupler.

### DETAILED DESCRIPTION OF THE INVENTION

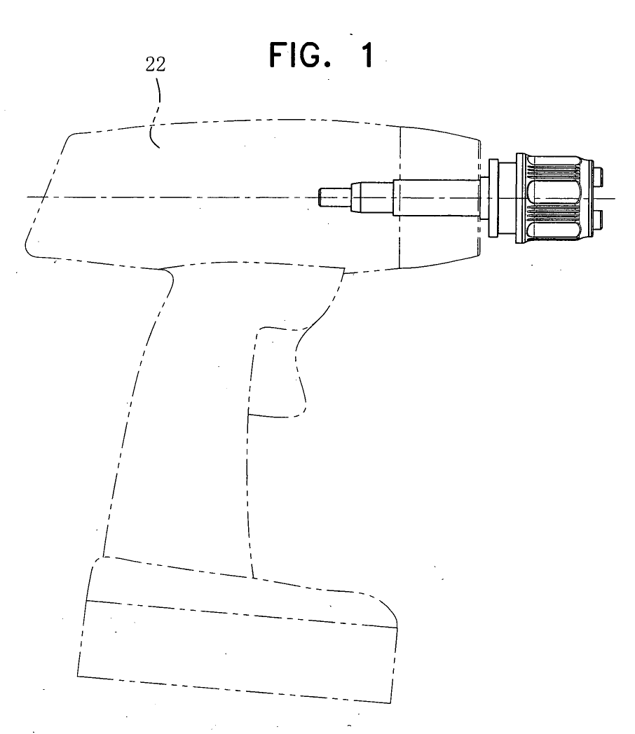

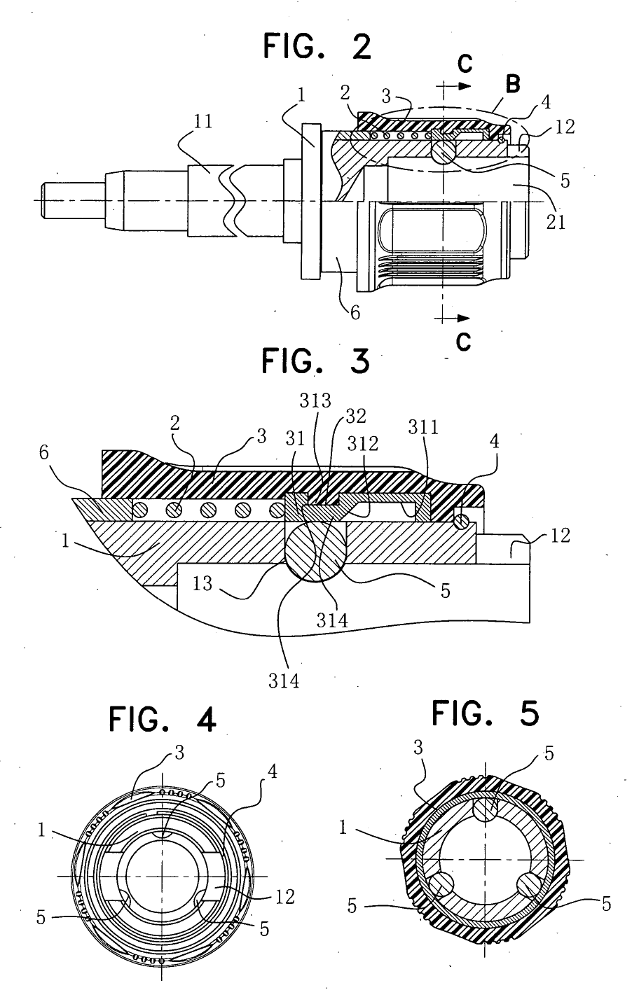

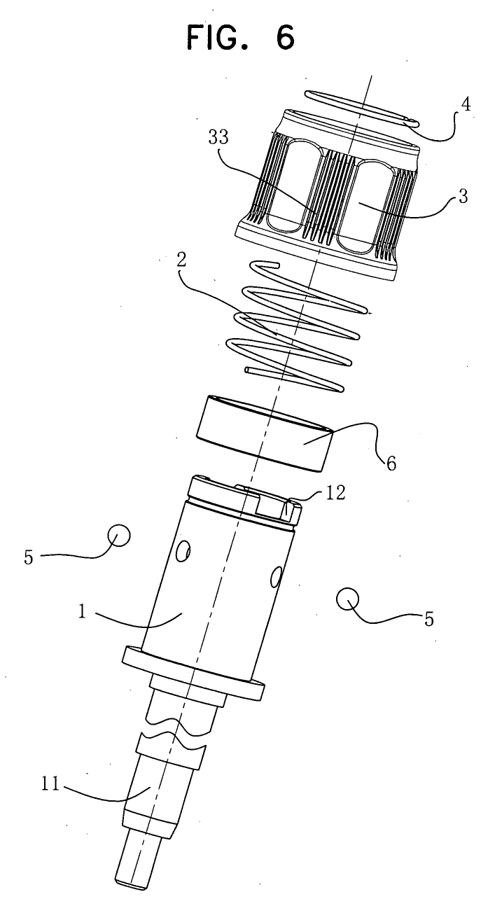

Referring to the drawings, the quick change coupler according to the present invention comprises a mainbody 1, the rear end of the mainbody 1 being equipped with a coupling arrangement for cooperating with a driving mechanism 22, the front end of the mainbody 1 being equipped with a tool coupling shaft cavity 21, a tool locking mechanism, and a torque transfer mechanism for cooperating with the tool. The driving mechanism 22 of the embodiment is an electrical drill, see FIG. 1.

The coupling arrangement can be a coupling shaft 11 integrated with the mainbody 1.

The locking mechanism comprises a short-cone shaped non through hole 13 positioned on the tail end of the coupling shaft cavity wall with steel balls 5 positioned therein, by which, the steel balls 5 are prevented from falling into the coupling shaft cavity 21. The locking mechanism also includes an operating sheath 3 with a raised platform 314 and a ring groove 311 positioned inside for cooperating with the steel balls 5. The spring 2 is positioned between the operating sheath 3 and the mainbody 1. A limiting clamp spring 4 is also provided to contact the operating sheath 3.

The operating sheath 3 is molded, using plastic or other easy-moldable materials, with several projections and grooves 33 molded peripherally, which can be comfortably held by hand and have an aesthetically pleasing shape. The spring 2 is arranged between the operating sheath 3 and the mainbody 1. The rear end of the spring 2 rests against a blocking sheath 6. A circular groove is positioned on the front end of the mainbody 1 with a clamp spring 4 arranged therein to perform a limiting function on the operating sheath 3. A wear resistant sheath 31 is placed in the operating sheath 3. The wear resistant sheath 31 includes a ring groove 311, a raised platform 314 and a connecting bevel 312 therebetween, and with a groove 313 positioned on the periphery. A projection 32 within the operating sheath 3 internally rests against the groove 313 for preventing the wear resistant sheath 31 from sliding out.

A square groove 12 with the function of torque transfer is positioned at the front end surface of the mainbody 1, wherein the square groove 12 performs the function of torque transfer;

The operating process of the quick change coupler of the present invention is as follows. When the operating sheath 3 is pulled backward, the spring 2 is compressed to allow the insertion of the tool or drill chuck into the hollow tool coupling shaft cavity 21 at the front end of the coupler mainbody 1. The outer surface of the tool joint or drill chuck joint presses the steel balls 5, so that they are subject to a radial force to move toward the periphery. When the coupler sheath 3 is pulled rearward, the ring groove 311 inside the coupler sheath 3 and the non-through hole 13 are aligned. At this point, the steel balls enter into the ring groove 311, thus the tool can be smoothly inserted into the coupler. When the coupler sheath 3 is released, the steel balls 5 move toward the center under the elastic force of the spring 2 and the camming force of the connecting bevel 312, and enter an arc groove of the tool, thus limiting the axial movement of the tool. In addition, the cooperation between the square groove 12 at the front end surface of the mainbody 1 and the commensurate shaped coupling keys on the tool perform the function of torque transfer. When the tool needs to be changed, the operating sheath 3 is pulled backward and the tool is pulled out.

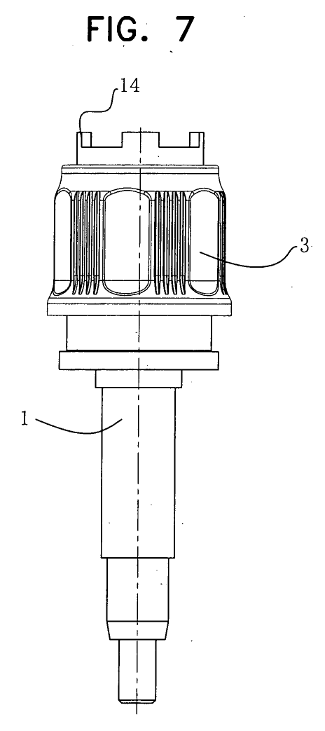

Shown in FIG. 7 is another embodiment of the present invention, wherein a plurality of protruding keys 14 are arranged at the front end surface of the mainbody 1. The other structures of the quick change coupler are identical to the explanation above.

1. A quick change coupler comprising a mainbody, a rear end of the mainbody having a coupling arrangement adapted to cooperate with a driving mechanism, a front end of the mainbody having a tool coupling shaft cavity,
wherein the mainbody is also equipped with a tool locking mechanism and a torque transfer mechanism for cooperating with the tool being coupled with the coupler, and
wherein the tool locking mechanism comprises at least one short-cone shaped non-through hole positioned at an inside end of the tool coupling shaft cavity wall with a ball positioned in each non-through hole, an operating sheath with a raised platform and a ring groove inside being provided for cooperating with each ball, a spring being installed between the operating sheath and the mainbody, and a limiting clamp spring being provided to contain the operating sheath.

2. The quick change coupler according to claim 1, wherein the coupling arrangement is a coupling shaft integrated with the mainbody.

3. The quick change coupler according to claim 1, wherein the coupling arrangement is a coupling shaft in threaded engagement with the mainbody.

4. The quick change coupler according to claim 1, wherein the coupling arrangement is a shaft cavity.

5. A quick change coupler comprising a mainbody, a rear end of the mainbody having a coupling arrangement adapted to cooperate with a driving mechanism, a front end of the mainbody having a tool coupling shaft cavity,
wherein the mainbody is also equipped with a tool locking mechanism and a torque transfer mechanism for cooperating with the tool being coupled with the coupler, and
wherein the tool locking mechanism comprises an oblique slot positioned on an inside surface of the tool coupling shaft cavity wall with locking rings equipped therein, an operating sheath being provided to engage the mainbody through a spring between the operating sheath and the mainbody, and a limiting clamp spring being provided to contain the operating sheath.

6. The quick change coupler according to claim 1, wherein the torque transfer mechanism is series of protruding keys positioned at the front end of the mainbody.

7. The quick change coupler according to claim 1, wherein the torque transfer mechanism is a groove positioned at the front end of the mainbody.

8. The quick change coupler according to claim 1, wherein a wear resistant sheath is placed within the operating sheath, the ring groove and the raised platform being positioned on an inner surface of the wear resistant sheath and a connecting bevel being between the ring groove and the raised platform.
